(19) United States
(12) Patent Application Publication
(10) Pub. No.: US 2012/0069598 A1
(43) Pub. Date: Mar. 22, 2012

(54) EDGE-TYPE BACKLIGHT MODULE

(75) Inventors: Chi-Sheng Chang, Taipei City (TW); Su-Yi Lin, Taipei County (TW); Cheng-Chuan Chen, Hsinchu County (TW)

(73) Assignee: AU OPTRONICS CORPORATION, Hsinchu (TW)

(21) Appl. No.: 12/982,857

(22) Filed: Dec. 30, 2010

(30) Foreign Application Priority Data
Sep. 17, 2010 (TW) 99131628

(51) Int. Cl. F21V 8/00

(52) U.S. Cl. 362/612

(57) ABSTRACT

An edge-type backlight module includes a light guide plate and at least one linear light source. The light guide plate has at least one light-incident sidewall, and the linear light source is substantially parallel to the light-incident sidewall. The linear light source includes a carrier and a plurality of solid-state light-emitting devices. The carrier is equally divided into a first, a second, a third, a fourth, and a fifth device mounting regions sequentially arranged along an extending direction of the carrier. The solid-state light-emitting devices are mounted on the device mounting regions and electrically connected to the carrier. An arrangement pitch of the solid-state light-emitting devices on the fourth device mounting region of the device mounting regions is greater than an arrangement pitch of the solid-state light-emitting devices on the other four device mounting regions.

### CROSS-REFERENCE TO RELATED APPLICATION

This application claims the priority benefit of Taiwan application serial no. 99131628, filed on Sep. 17, 2010. The entirety of the above-mentioned patent application is hereby incorporated by reference herein and made a part of this specification.

### BACKGROUND OF THE INVENTION

1. Field of the Invention

The invention relates to an edge-type backlight module. More particularly, the invention relates to an edge-type backlight module using solid-state light-emitting devices as light sources.

2. Description of Related Art

In recent years, liquid crystal displays (LCDs) developed toward full-color display gradually replace a conventional cathode ray tubes (CRTs) display and has become a main stream of displays in the market due to the advantages of a low operation voltage, non-radiation, light weight, small volume occupancy, and so forth.

The LCDs are non-self-illuminating, and therefore display functions of the LCDs are achieved when required light is provided by a backlight module. With increasing consciousness of environmental protection, cold cathode fluorescent lamps (CCFL) used in a conventional backlight module are gradually replaced by light-emitting diode (LED) devices because the LED devices are more friendly to environment. When the LED devices are applied to the backlight module, e.g., an edge-type backlight module, the LED devices are usually mounted on a bar-shaped printed circuit board (PCB) to form an LED light bar. The LED light bar is often electrically connected to a control circuit board through a flexible printed circuit (FPC).

According to the related art, the LED devices in the LED light bar are located in different positions and thus have different working temperatures. There may be a 10° C. difference or more between the highest working temperature and the lowest working temperature in an exemplary 42-inch or 55-inch LCD panel. The working temperature considerably affects luminance, chromaticity, and life spans of the LED devices; therefore, some LED devices operating under a relatively high working temperature may decay more rapidly after a long period of use, which leads to significant reduction of life time of the backlight module.

Since different working temperatures result in different life spans of the LED devices, how to lessen the difference in the working temperatures of the LED devices at different positions of the LED light bar becomes an important issue to be resolved immediately.

### SUMMARY OF THE INVENTION

The invention is directed to an edge-type backlight module in which solid-state light-emitting devices are not apt to have reduced life time caused by concentrated heat.

The invention provides an edge-type backlight module that includes a light guide plate and at least one linear light source. The light guide plate has at least one light-incident sidewall, and the linear light source is substantially parallel to the light-incident sidewall. The linear light source includes a carrier and a plurality of solid-state light-emitting devices. The carrier is equally divided into five device mounting regions (i.e. a first, a second, a third, a fourth, and a fifth device mounting regions) sequentially arranged along an extending direction of the carrier. The solid-state light-emitting devices are mounted on the device mounting regions of the carrier and electrically connected to the carrier. An arrangement pitch of the solid-state light-emitting devices on the fourth device mounting region is greater than an arrangement pitch of the solid-state light-emitting devices on the other four device mounting regions.

The invention further provides an edge-type backlight module that includes a light guide plate and at least one linear light source. The light guide plate has at least one light-incident sidewall, and the linear light source is substantially parallel to the light-incident sidewall. The linear light source includes a carrier and a plurality of solid-state light-emitting devices. The carrier is equally divided into five device mounting regions (i.e. a first, a second, a third, a fourth, and a fifth device mounting regions) sequentially arranged along an extending direction of the carrier. The solid-state light-emitting devices are mounted on the device mounting regions of the carrier and electrically connected to the carrier. Normal forward voltage (Vf) bins of the solid-state light-emitting devices on the fourth device mounting region are lower than normal Vf bins of the solid-state light-emitting devices on the other four device mounting regions.

The invention further provides an edge-type backlight module that includes a light guide plate and at least one linear light source. The light guide plate has at least one light-incident sidewall, and the linear light source is substantially parallel to the light-incident sidewall. The linear light source includes a carrier and a plurality of solid-state light-emitting devices. The carrier is equally divided into five device mounting regions (i.e. a first, a second, a third, a fourth, and a fifth device mounting regions) sequentially arranged along an extending direction of the carrier. The solid-state light-emitting devices are mounted on the device mounting regions of the carrier and electrically connected to the carrier. When a driving current is fixed, pulse-width modulated (PWM) signals for driving the solid-state light-emitting devices on the fourth device mounting region have duty ratios lower than duty ratios of PWM signals for driving the solid-state light-emitting devices on the other four device mounting regions.

The invention further provides an edge-type backlight module that includes a light guide plate and at least one linear light source. The light guide plate has at least one light-incident sidewall, and the linear light source is substantially parallel to the light-incident sidewall. The linear light source includes a carrier and a plurality of solid-state light-emitting devices. The carrier is equally divided into five device mounting regions (i.e. a first, a second, a third, a fourth, and a fifth device mounting regions) sequentially arranged along an extending direction of the carrier. The solid-state light-emitting devices are mounted on the device mounting regions of the carrier and electrically connected to the carrier. A driving current for driving the solid-state light-emitting devices on the fourth device mounting region is smaller than driving currents for driving the solid-state light-emitting devices on the other four device mounting regions.

In the invention, the arrangement pitch of the solid-state light-emitting devices is adjusted, different normal Vf bins are applied to the solid-state light-emitting devices, and the solid-state light-emitting devices are driven by the PWM signals with different duty ratios or driven by different driving currents. Thereby, the solid-state light-emitting devices are not apt to have reduced life time caused by concentrated heat, and the edge-type backlight module can have the extended life span.

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates correlations between different horizontal regions in a conventional edge-type backlight module and working temperatures of the conventional edge-type backlight module.

FIG. 2 is a front view illustrating an edge-type backlight module according to a first embodiment of the invention.

FIG. 3A is a schematic cross-sectional view taken along a cross-section A-A′ depicted in FIG. 2.

FIG. 3B is a schematic cross-sectional view taken along a cross-section B-B′ depicted in FIG. 2.

FIG. 4 is a schematic cross-sectional view illustrating an edge-type backlight module according to a second embodiment of the invention.

FIG. 5 is a schematic cross-sectional view illustrating an edge-type backlight module according to a third embodiment of the invention.

FIG. 6 is a schematic cross-sectional view illustrating an edge-type backlight module according to a fourth embodiment of the invention.

FIG. 7A illustrates correlations between different horizontal regions in a conventional edge-type backlight module and working temperatures of the conventional edge-type backlight module.

FIG. 7B illustrates correlations between different horizontal regions in an edge-type backlight module and working temperatures of the edge-type backlight module according to the fourth embodiment of the invention.

### DETAILED DESCRIPTION OF EMBODIMENTS

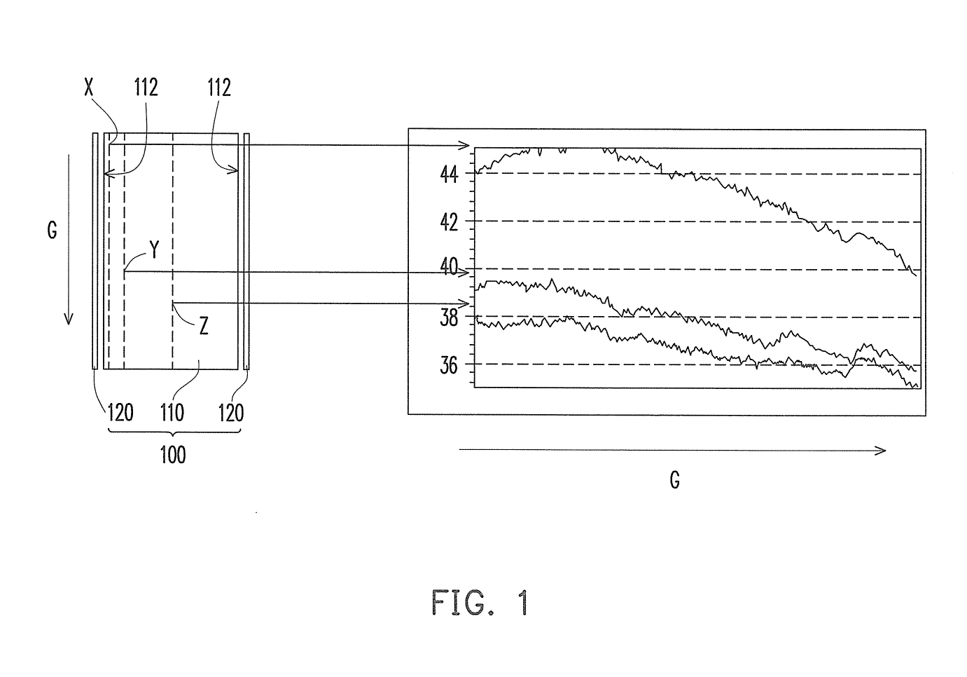

FIG. 1 illustrates correlations between different horizontal regions in a conventional edge-type backlight module and working temperatures of the conventional edge-type backlight module. With reference to FIG. 1, the conventional edge-type backlight module 100 includes a light guide plate 110 and two opposite linear light sources 120. The light guide plate 110 has two opposite light-incident sidewalls 112. Each of the linear light sources 120 is substantially parallel to the light-incident sidewalls 112 and includes a carrier and a plurality of solid-state light-emitting devices (not shown). Note that the solid-state light-emitting devices are equidistantly arranged on the carrier, and no mal Vf bins of all of the solid-state light-emitting devices are the same. Theoretically, when the solid-state light-emitting devices are equidistantly arranged on the carrier, and the normal Vf bins of all of the solid-state light-emitting devices are the same, working temperatures of different regions on the linear light sources 120 should be similar. After the temperatures of different regions on the linear light sources 120 are actually measured, however, a 10° C. difference or more is found between the highest working temperature and the lowest working temperature in an exemplary 42-inch or 55-inch LCD panel. As shown in FIG. 1, when the working temperatures of different regions of the light guide plate 110 are respectively measured from bottom to top along paths X, Y, and Z (i.e., along a direction opposite to the direction G of gravity), the measured working temperatures first rise and then drop, and the highest working temperature is not found at the topmost region of the light guide plate 110. The path X is close to the left linear light source 120, and therefore the temperatures measured along the path X are relatively high. The temperatures measured along the paths Y and Z are relatively low while more further away from the light source. Note that the temperatures measured from bottom to top remain first increasing and then decreasing.

When the temperatures of different regions of the linear light sources 120 are measured from bottom to top of two respective sides (i.e., the back plates) of the edge-type backlight module 100, the measured temperatures also rise and then drop. The temperature gradient of the back plates is approximately 0.1° C./cm, and the highest working temperature is not found at the topmost regions of the linear light sources 120. Besides, if the temperatures of the solid-state light-emitting devices (e.g., temperatures of lenses of an LED package) are directly measured, the temperature gradient is approximately 0.2° C./cm, and there can be a 13.6° C. difference for 42-inch panel between the highest temperature and the lowest temperature of the lenses in different regions of the linear light sources 120. The temperature different could be much larger for different sizes of the panel and different kinds of materials

According to the invention and researches that are related thereto, the working temperatures at different regions of the linear light sources 120 are different because of air convection in the edge-type backlight module 100 according to researches. Specifically, when extending directions of the linear light sources 120 are parallel to the direction G of gravity, heat generated by the solid-state light-emitting devices is transmitted in a direction opposite to the direction G of gravity, and the difference in the working temperatures at different regions of the linear light sources 120 is relevant to the direction G of gravity to a certain extent.

In consideration of the above, uniformity of the working temperatures of the linear light sources 120 is improved in the invention, and then the edge-type backlight module can have the extended life span, as described in the following embodiments.

### First Embodiment

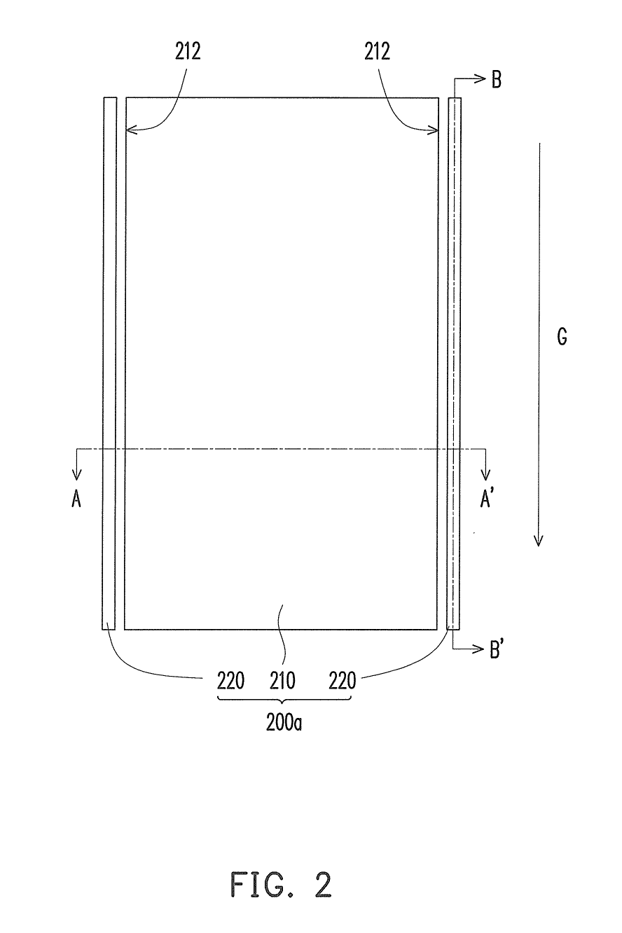

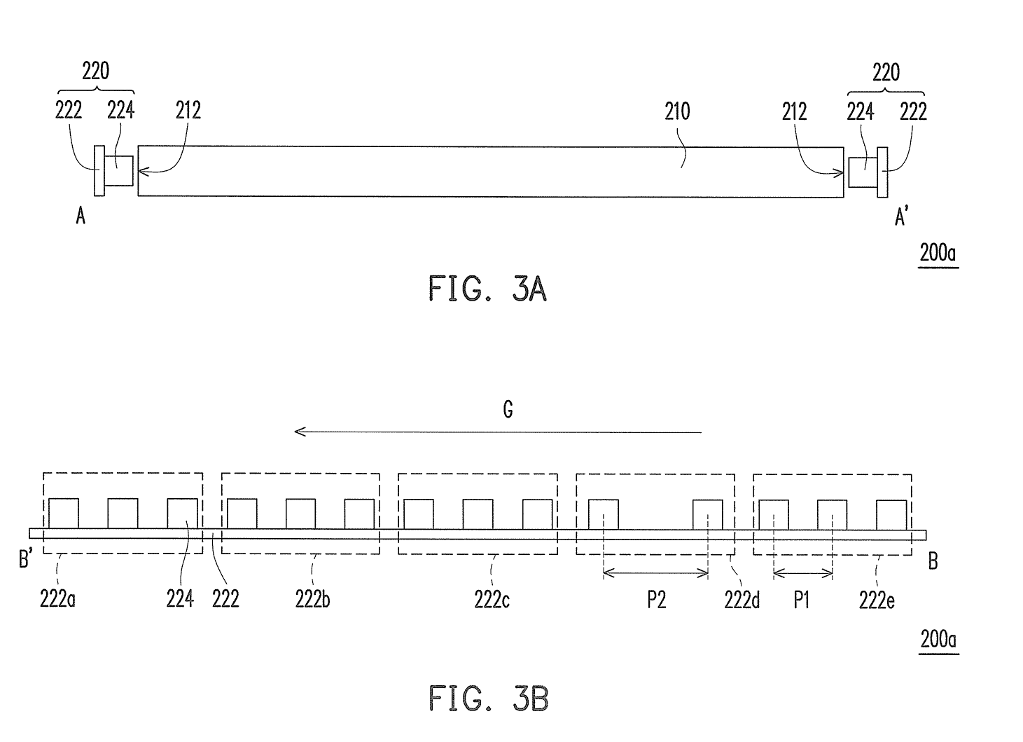

FIG. 2 is a front view illustrating an edge-type backlight module according to a first embodiment of the invention. FIG. 3A is a schematic cross-sectional view taken along a cross-section A-A′ depicted in FIG. 2. FIG. 3B is a schematic cross-sectional view taken along a cross-section B-B′ depicted in FIG. 2. With reference to FIG. 2, FIG. 3A, and FIG. 3B, the edge-type backlight module 200a of this embodiment includes a light guide plate 210 and at least one linear light source 220. The light guide plate 210 has at least one light-incident sidewall 212, and the linear light source 220 is substantially parallel to the light-incident sidewall 212. The linear light source 220 includes a carrier 222 and a plurality of solid-state light-emitting devices 224. As shown in FIG. 2, the light guide plate 210 has a pair of light-incident sidewalls 212 parallel to each other, and the number of the linear light sources 220 is two. The two linear light sources 220 are substantially parallel to the pair of light-incident sidewalls 212. Note that the number of the light-incident sidewalls of the light guide plate 210 and the number of the linear light sources 220 are not limited in the invention, and people having ordinary skill in the art are able to appropriately modify the design of the light guide plate 210 and the linear light sources 220 based on design requirements of products. For instance, in another embodiment of the invention, the edge-type backlight module 200a can have one light-incident direction. Namely, the light guide plate 210 has one light-incident sidewall 212 and one linear light source 220 corresponding to the light-incident sidewall 212.

In this embodiment, the carrier 222 is, for instance, a bar-shaped circuit board that can be a normal printed circuit board (PCB) or a metal core printed circuit board (MCPCB) that is characterized by favorable heat conductivity. The solid-state light-emitting devices 224 are, for instance, LED packages that can be surface mount devices (SMD) or other appropriate packages, which should not be construed as a limitation to the invention.

The carrier 222 is equally divided into five device mounting regions sequentially arranged along an extending direction of the carrier 222, i.e., the first device mounting region 222a, the second device mounting region 222b, the third device mounting region 222c, the fourth device mounting region 222d, and the fifth device mounting region 222e. The solid-state light-emitting devices 224 are mounted on each of the device mounting regions 220a, 220b, 220c, 220d, and 220e of the carrier 222 and electrically connected to the carrier 222. In this embodiment, the first device mounting region 222a, the second device mounting region 222b, the third device mounting region 222c, the fourth device mounting region 222d, and the fifth device mounting region 222e are sequentially arranged along a direction opposite to the direction G of gravity.

As indicated in FIG. 3B, an arrangement pitch P2 between the solid-state light-emitting devices 224 on the fourth device mounting region 222d is greater than an arrangement pitch P1 between the solid-state light-emitting devices 224 on the other four device mounting regions (i.e., the first device mounting region 222a, the second device mounting region 222b, the third device mounting region 222c, and the fifth device mounting region 222e). In this embodiment, the arrangement pitch P1 between the solid-state light-emitting devices 224 on the first device mounting region 222a, the second device mounting region 222b, the third device mounting region 222c, and the fifth device mounting region 222e is identical, for instance. Certainly, in other embodiments of the invention, the arrangement pitch P1 between the solid-state light-emitting devices 224 on the first device mounting region 222a, the second device mounting region 222b, the third device mounting region 222c, and the fifth device mounting region 222e can be gradually reduced from the fourth device mounting region 222d to two sides of the carrier 222.

Since the arrangement pitch P2 between the solid-state light-emitting devices 224 on the fourth device mounting region 222d is relatively large, the design of the light guide plate 210 can be partially modified in this embodiment. Specifically, density and dimensions of mesh points and V-shaped slots on parts of the regions of the light guide plate 210 corresponding to the fourth device mounting region 220d can be changed in this embodiment, such that the planar light source provided by the light guide plate 210 can have uniform luminance.

### Second Embodiment

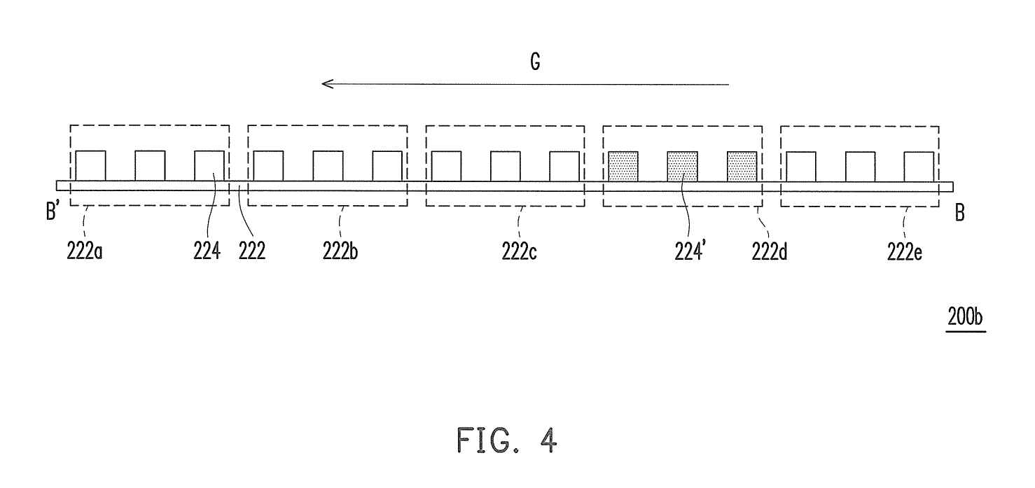

FIG. 4 is a schematic cross-sectional view illustrating an edge-type backlight module according to a second embodiment of the invention. With reference to FIG. 4, the edge-type backlight module 200b of this embodiment is similar to the edge-type backlight module 200a of the first embodiment, while the main difference therebetween lies in that normal Vf bins of the solid-state light-emitting devices 224′ on the fourth device mounting region 222d are lower than normal Vf bins of the solid-state light-emitting devices 224 on the other four device mounting regions 222a, 222b, 222c, and 222e. Besides, the arrangement pitch of the solid-state light-emitting devices 224′ on the fourth device mounting region 222d is identical to the arrangement pitch of the solid-state light-emitting devices 224 on the other four device mounting regions 222a, 222b, 222c, and 222e.

In this embodiment, the normal Vf bins of the solid-state light-emitting devices 224 on the first device mounting region 222a, the second device mounting region 222b, the third device mounting region 222c, and the fifth device mounting region 222e are identical, for instance. Certainly, in other embodiments of the invention, the normal Vf bins of the solid-state light-emitting devices 224 on the first device mounting region 222a, the second device mounting region 222b, the third device mounting region 222c, and the fifth device mounting region 222e can be gradually increased from the fourth device mounting region 222d to two respective sides. Note that when at least two types of solid-state light-emitting devices 224 and 224′ are in stock, these two types of solid-state light-emitting devices 224 and 224′ can both be used for fabricating the edge-type backlight module 200b.

Since the normal Vf bins of the solid-state light-emitting devices 224′ on the fourth device mounting region 222d are relatively small, the design of the light guide plate 210 can be partially modified in this embodiment. Specifically, density and dimensions of mesh points and V-shaped slots on parts of the regions of the light guide plate 210 corresponding to the fourth device mounting region 220d can be changed in this embodiment, such that the planar light source provided by the light guide plate 210 can have uniform luminance.

### Third Embodiment

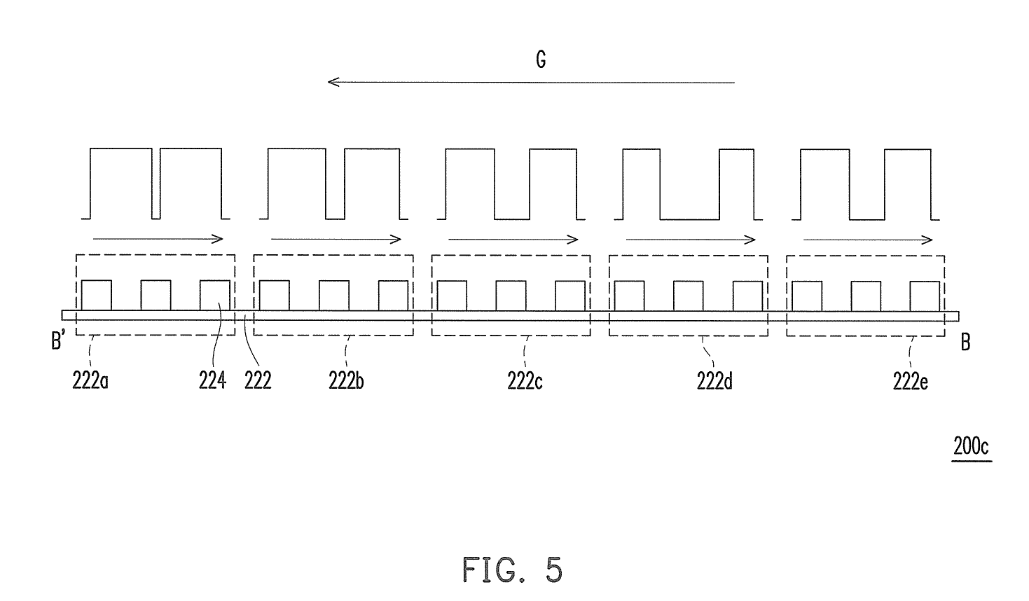

FIG. 5 is a schematic cross-sectional view illustrating an edge-type backlight module according to a third embodiment of the invention. With reference to FIG. 5, the edge-type backlight module 200c of this embodiment is similar to the edge-type backlight module 200a of the first embodiment, while the main difference therebetween lies in that PWM signals for driving the solid-state light-emitting devices 224 on the fourth device mounting region 222d have duty ratios lower than duty ratios of PWM signals for driving the solid-state light-emitting devices 224 on the other four device mounting regions 222a, 222b, 222c, and 222e when the driving current is fixed. Besides, the arrangement pitch of the solid-state light-emitting devices 224 on the fourth device mounting region 222d is identical to the arrangement pitch of the solid-state light-emitting devices 224 on the other four device mounting regions 222a, 222b, 222c, and 222e.

In this embodiment, the PWM signals for driving the solid-state light-emitting devices 224 on the first device mounting region 222a, the second device mounting region 222b, the third device mounting region 222c, and the fifth device mounting region 222e have the same duty ratio, for instance. Certainly, in other embodiments of the invention, the PWM signals for driving the solid-state light-emitting devices 224 on the first device mounting region 222a, the second device mounting region 222b, the third device mounting region 222c, and the fifth device mounting region 222e have the duty ratios that are gradually increased from the fourth device mounting region 222d to two respective sides.

Since the duty ratios of the PWM signals for driving the solid-state light-emitting devices 224 on the fourth device mounting region 222d are relatively low, the design of the light guide plate 210 can be partially modified in this embodiment. Specifically, density and dimensions of mesh points and V-shaped slots on parts of the regions of the light guide plate 210 corresponding to the fourth device mounting region 220d can be changed in this embodiment, such that the planar light source provided by the light guide plate 210 can have uniform luminance.

### Fourth Embodiment

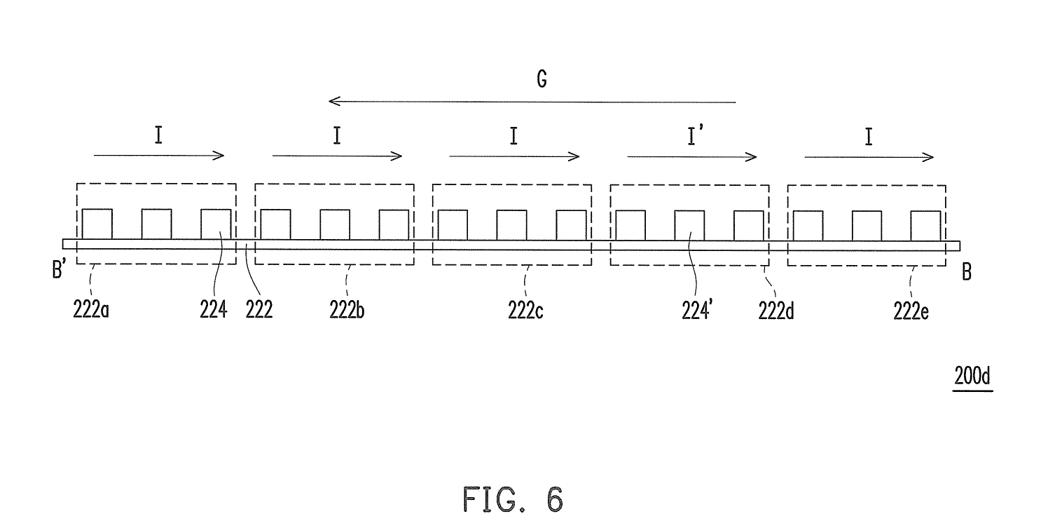

FIG. 6 is a schematic cross-sectional view illustrating an edge-type backlight module according to a fourth embodiment of the invention. With reference to FIG. 6, the edge-type backlight module 200d of this embodiment is similar to the edge-type backlight module 200c of the third embodiment, while the main difference therebetween lies in that a driving current I′ for driving the solid-state light-emitting devices 224′ on the fourth device mounting region 222d is smaller than driving currents I for driving the solid-state light-emitting devices 224 on the other four device mounting regions 222a, 222b, 222c, and 222e.

In this embodiment, the driving currents I for driving the solid-state light-emitting devices 224 on the first device mounting region 222a, the second device mounting region 222b, the third device mounting region 222c, and the fifth device mounting region 222e are identical, for instance. Certainly, in other embodiments of the invention, the driving currents I for driving the solid-state light-emitting devices 224 on the first device mounting region 222a, the second device mounting region 222b, the third device mounting region 222c, and the fifth device mounting region 222e can be gradually increased from the fourth device mounting region 222d to two respective sides.

Since the driving current I′ for driving the solid-state light-emitting devices 224 on the fourth device mounting region 222d is relatively small, the design of the light guide plate 210 can be partially modified in this embodiment. Specifically, density and dimensions of mesh points and V-shaped slots on parts of the regions of the light guide plate 210 corresponding to the fourth device mounting region 220d can be changed in this embodiment, such that the planar light source provided by the light guide plate 210 can have uniform luminance.

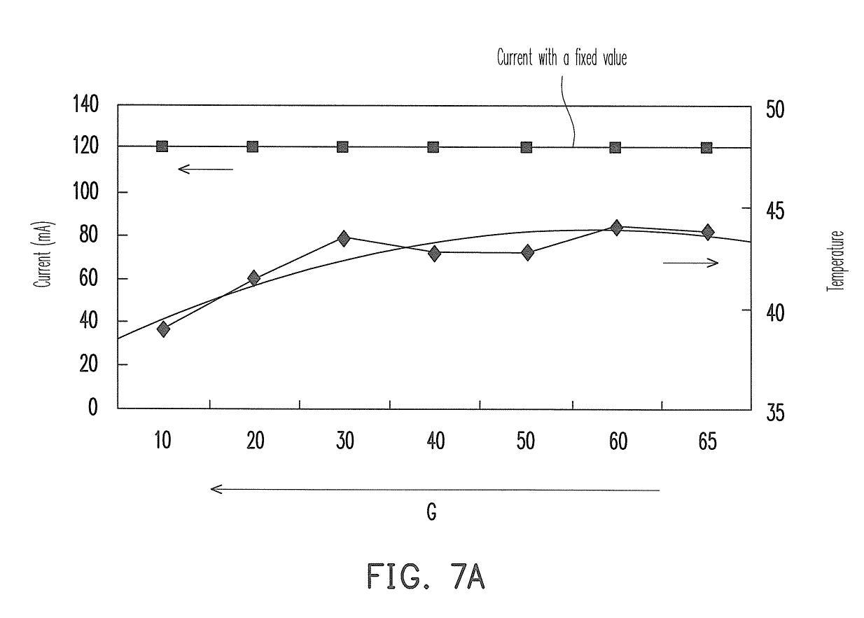

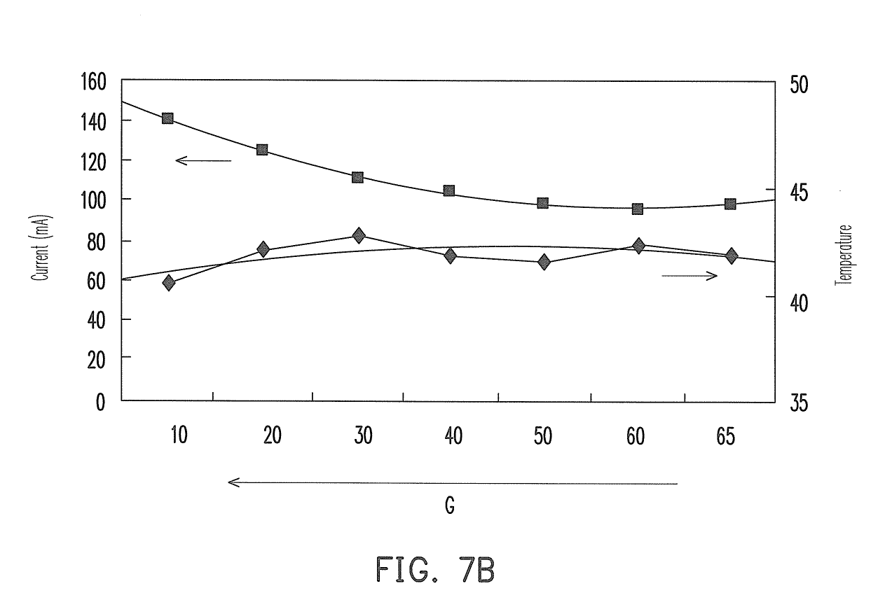

FIG. 7A illustrates correlations between different horizontal regions in a conventional edge-type backlight module and working temperatures of the conventional edge-type backlight module. FIG. 7B illustrates correlations between different horizontal regions in an edge-type backlight module and working temperatures of the edge-type backlight module according to the fourth embodiment of the invention. With reference to FIG. 7A and FIG. 7B, the broken lines represent data that are actually measured, and curves that adjoin the broken lines are trend lines showing temperature variation. If the solid-state light-emitting devices 224 on the device mounting regions 222a, 222b, 222c, 222d, and 222e are driven by a constant current of about 120 mA, the temperature variation is rather apparent, as indicated in FIG. 7A. If, however, the solid-state light-emitting devices 224 on the device mounting regions 222a, 222b, 222c, 222d, and 222e are driven by the driving currents I and I′ that fit the trend lines, the temperature variation is rather subtle, as indicated in FIG. 7B

As described in the previous embodiments of the invention, the arrangement pitch of the solid-state light-emitting devices is adjusted, different normal Vf bins are applied to the solid-state light-emitting devices, and the solid-state light-emitting devices are driven by the PWM signals with different duty ratios or driven by different driving currents. Thereby, the solid-state light-emitting devices are not apt to have reduced life time caused by concentrated heat, and then the edge-type backlight module can have the extended life span.

It will be apparent to those skilled in the art that various modifications and variations can be made to the invention without departing from the scope or spirit of the invention. In view of the foregoing, it is intended that the invention cover modifications and variations of this invention provided they fall within the scope of the following claims and their equivalents.

What is claimed is:

1. An edge-type backlight module comprising:
a light guide plate having at least one light-incident sidewall;
at least one linear light source arranged substantially parallel to the at least one light-incident sidewall and comprising:
a carrier equally divided into a first, a second, a third, a fourth, and a fifth device mounting regions sequentially arranged along an extending direction of the carrier; and
a plurality of solid-state light-emitting devices mounted on the first, the second, the third, the fourth, and the fifth device mounting regions of the carrier and electrically connected to the carrier, wherein an arrangement pitch of the solid-state light-emitting devices on the fourth device mounting region is greater than an arrangement pitch of the solid-state light-emitting devices on the other four device mounting regions.

2. The edge-type backlight module as claimed in claim 1, wherein the at least one light-incident sidewall is substantially parallel to a direction of gravity.

3. The edge-type backlight module as claimed in claim 2, wherein the first, the second, the third, the fourth, and the fifth device mounting regions sequentially arranged along a direction opposite to the direction of gravity.

4. The edge-type backlight module as claimed in claim 1, wherein the arrangement pitch of the solid-state light-emitting devices is gradually decreased from the fourth device mounting region to two sides of the carrier.

5. The edge-type backlight module as claimed in claim 1, wherein the arrangement pitch of the solid-state light-emitting devices on the first, the second, the third, and the fifth device mounting regions is identical.

6. The edge-type backlight module as claimed in claim 1, wherein the carrier comprises a circuit board.

7. The edge-type backlight module as claimed in claim 1, wherein the solid-state light-emitting devices comprise light-emitting diode packages.

8. The edge-type backlight module as claimed in claim 1, wherein the light guide plate comprises a pair of light-incident sidewalls parallel to each other, and the at least one linear light source comprises two linear light sources substantially parallel to the pair of light-incident sidewalls.

9. An edge-type backlight module comprising:
a light guide plate having at least one light-incident sidewall;
at least one linear light source arranged substantially parallel to the at least one light-incident sidewall and comprising:
a carrier equally divided into a first, a second, a third, a fourth, and a fifth device mounting regions sequentially arranged along an extending direction of the carrier; and
a plurality of solid-state light-emitting devices mounted on the first, the second, the third, the fourth, and the fifth device mounting regions of the carrier and electrically connected to the carrier, wherein normal forward voltage bins of the solid-state light-emitting devices on the fourth device mounting region are lower than normal forward voltage bins of the solid-state light-emitting devices on the first, the second, the third, and the fifth device mounting regions.

10. The edge-type backlight module as claimed in claim 9, wherein the at least one light-incident sidewall is substantially parallel to a direction of gravity.

11. The edge-type backlight module as claimed in claim 10, wherein the first, the second, the third, the fourth, and the fifth device mounting regions are sequentially arranged along a direction opposite to the direction of gravity.

12. The edge-type backlight module as claimed in claim 9, wherein the carrier comprises a circuit board.

13. The edge-type backlight module as claimed in claim 9, wherein the solid-state light-emitting devices comprise light-emitting diode packages.

14. The edge-type backlight module as claimed in claim 9, wherein the light guide plate comprises a pair of light-incident sidewalls parallel to each other, and the at least one linear light source comprises two linear light sources substantially parallel to the pair of light-incident sidewalls.

15. An edge-type backlight module comprising:
a light guide plate having at least one light-incident sidewall;
at least one linear light source arranged substantially parallel to the at least one light-incident sidewall and comprising:
a carrier equally divided into a first, a second, a third, a fourth, and a fifth device mounting regions sequentially arranged along an extending direction of the carrier; and
a plurality of solid-state light-emitting devices mounted on the first, the second, the third, the fourth, and the fifth device mounting regions of the carrier and electrically connected to the carrier, when a driving current is fixed, pulse-width modulated signals for driving the solid-state light-emitting devices on the fourth device mounting region have duty ratios lower than duty ratios of pulse-width modulated signals for driving the solid-state light-emitting devices on the first, the second, the third, and the fifth device mounting regions.

16. The edge-type backlight module as claimed in claim 15, wherein the at least one light-incident sidewall is substantially parallel to a direction of gravity.

17. The edge-type backlight module as claimed in claim 16, wherein the first, the second, the third, the fourth, and the fifth device mounting regions are sequentially arranged along a direction opposite to the direction of gravity.

18. The edge-type backlight module as claimed in claim 15, wherein the carrier comprises a circuit board.

19. The edge-type backlight module as claimed in claim 15, wherein the solid-state light-emitting devices comprise light-emitting diode packages.

20. The edge-type backlight module as claimed in claim 15, wherein the light guide plate comprises a pair of light-incident sidewalls parallel to each other, and the at least one linear light source comprises two linear light sources substantially parallel to the pair of light-incident sidewalls.

21. An edge-type backlight module comprising:
a light guide plate having at least one light-incident sidewall;
at least one linear light source arranged substantially parallel to the at least one light-incident sidewall and comprising:
a carrier equally divided into a first, a second, a third, a fourth, and a fifth device mounting regions sequentially arranged along an extending direction of the carrier; and
a plurality of solid-state light-emitting devices mounted on the first, the second, the third, the fourth, and the fifth device mounting regions of the carrier and electrically connected to the carrier, wherein a driving current for driving the solid-state light-emitting devices on the fourth device mounting region is smaller than driving currents for driving the solid-state light-emitting devices on the first, the second, the third, and the fifth device mounting regions.

22. The edge-type backlight module as claimed in claim 21, wherein the at least one light-incident sidewall is substantially parallel to a direction of gravity.

23. The edge-type backlight module as claimed in claim 22, wherein the first, the second, the third, the fourth, and the fifth device mounting regions are sequentially arranged along a direction opposite to the direction of gravity.

24. The edge-type backlight module as claimed in claim 21, wherein the carrier comprises a circuit board.

25. The edge-type backlight module as claimed in claim 21, wherein the solid-state light-emitting devices comprise light-emitting diode packages.

26. The edge-type backlight module as claimed in claim 21, wherein the light guide plate comprises a pair of light-incident sidewalls parallel to each other, and the at least one linear light source comprises two linear light sources substantially parallel to the pair of light-incident sidewalls.
